(19) United States
(12) Patent Application Publication
(10) Pub. No.: US 2003/0034198 A1
(43) Pub. Date: Feb. 20, 2003

(54) Dilatant earcup soft seal

(76) Inventors: William B. Cushman, Pensacola, FL (US); Mark W. Stevenson, Germantown, MD (US)

Correspondence Address: William B. Cushman, 1315 Finley Drive, Pensacola, FL, 32514, US

(21) Appl. No.: 09/933,235

(22) Filed: Aug. 20, 2001

(51) Int. Cl. H04R 25/00

(52) U.S. Cl. 181/129; 181/126

(57) ABSTRACT

A dilatant circumaural hearing protection earcup soft seal is disclosed. The design of the instant invention is predicated on the theory that the primary function of an effective earcup soft seal is to hold the earcup it is attached to stiffly against the user's head. Experimental evidence shows that an earcup is “pumped” in response to acoustic pressure and reconstructs the acoustic signal inside the earcup as a diaphragm, even though very little noise may pass directly through the earcup itself. The soft seals of the instant invention utilize the dilatant property of some materials to provide a soft seal that conforms slowly and comfortably to a user's head but is stiff under the influence of high shear rate acoustic pressure.

### BACKGROUND OF THE INVENTION

1. Field of the Invention

The instant invention relates to noise-protection circumaural earcups and other like headgear incorporating ear protectors designed to reduce noise levels, more particularly to the soft seal deployed between the noise-protection circumaural earcup and the user of said noise-protection circumaural earcup.

2. Description of Related Art

In late 1993 and early 1994 William B. Cushman, Ph.D., Poiesis Research, Inc., and Gerald B. Thomas, Ph.D., Navy Aerospace Medical Research Laboratory, developed and patented a promising new technology for preventing sound transmission within polymer materials (Cushman, et al., “Acoustic attenuation and vibration damping materials” U.S. Pat. No. 5,400,296, issued Mar. 21, 1995.). These new acoustic materials were based on Cushman's suggestion that propagating acoustic energy within a medium-impedance material such as a polymer could be scattered and dissipated by embedding a mix of high and low impedance particles within the polymer. Local reflections at interfaces with high impedance particles (iron, for example) would be in phase with the propagating energy, but local reflections with low impedance particles (the hollow portion of ceramic microspheres, for example) would be out of phase. This reflected energy would interact algebraically. Tests of trial materials based on this principle indicated that such materials would be ideal for a hearing protection earcup.

Poiesis Research made experimental earcups which proved to be extremely effective. Earcups with attenuation of 45 dB at 10 Hz were demonstrated. Results in fact may be better than 45 dB at 10 Hz because testing was limited by the available energy within the test apparatus. Earcups with more than 50 dB of attenuation would be superfluous, however, as bone conduction would mask any further attenuation.

The new experimental earcups were very nearly perfect, but when they were placed on a conventional soft seal all the apparent advantages of the new experimental materials disappeared. An earcup/soft-seal system is only as good as its weakest link, and the weak link in this case was the soft seal. The question was then one of identifying the mode by which the soft seal was failing and finding a way to counteract this failure mode. Experiments demonstrated that to maintain hearing protection “perfection” an earcup must be rigidly suspended and rigidly constructed. Placing an earcup directly on a flat-plate coupler with no mechanically decoupling soft components between the earcup and the coupler effectively holds the earcup rigidly in space and accounts for the excellent data initially obtained. If, however, the earcup is allowed to move in response to impinging pressure waves, as it does when mounted on a conventional soft seal, it will act as a diaphragm on the inside and reconstruct the externally impinging acoustic energy internally. No energy at all has to pass through the material of the earcup in order to completely destroy its effectiveness via this mechanism. The hearing protection earcup has a great deal in common with a stethoscope. A stethoscope uses the large area of its diaphragm to funnel acoustic pressure to the much smaller area of the tubes leading to the user's ears. The difference in area between the diaphragm and the tubes thus magnifies the amplitude of air movement at the user's ears by the ratio of the two areas. In the case of an earcup with an area of roughly 100 cm², acting as a diaphragm funneling acoustic pressure to an external auditory meatus with an area less than 1 cm², this amplitude increase is 100 to 1.

In actual practice there are mitigating circumstances. Impedance mismatches between air and the material of the earcup shell cause most impinging acoustic energy to be reflected. The earcup has mass, and this mass limits the acceleration of the earcup and the magnitude of resulting movement. Most importantly, the material of the soft seal has at least a slight damping effect. In addition, as the internal volume of an earcup increases the earcup's performance increases proportionally.

The design of an effective hearing protection earcup and soft seal thus reduces to four basic procedures: 1) Either use advanced materials or a structurally stiff design (or ideally, both) for the earcup. Either approach will produce an earcup that is likely to be superior to the soft seal it is used with if that soft seal is of conventional design. 2) Increase the earcup's mass (within practical limits), which reduces the magnitude of the earcup's acceleration from impinging acoustic pressure. 3) Increase soft seal damping to reduce earcup excursions, or increase soft seal stiffness enough to prevent them. The soft seal must conform to the contours of a user's head and this requirement places a practical limit on static stiffness, but not dynamic stiffness. 4) Increase the internal volume of the earcup as much as possible within practical constraints.

By far the most difficult requirement in designing an effective noise-protection earcup and soft seal is that the soft seal must restrict the movement of the earcup. Movement may be restricted either through damping or direct mechanical stiffness. Mechanical stiffness is generally avoided because discomfort for the user is usually associated with a stiff seal. Conventional earcup soft seals make use of viscous damping that results from turbulence in the air flowing through the pores of open-celled slow-recovery foams. Liquids or gels within various internal soft seal structures also may provide damping. One attempt to restrict earcup movement was made by saturating the slow-recovery foam of a conventional soft seal with glycerin. The much greater viscosity and mass of glycerin greatly enhanced the slow-recovery foam's damping capability. Glycerin saturation increased the attenuation of the earcup and soft seal system by roughly 7.5 dB over a range of 10 to 2000 Hz relative to a conventional open-celled slow-recovery foam soft seal. This improvement was encouraging, but still did not come close to the capability of the new experimental earcup.

Urella, et al. (U.S. Pat. No. 5,138,722) teach the use of dilatant materials in an earcup soft seal. They note that when Dow Corning® 3179 Dilatant Compound and Dow Corning® Q13563 silicone fluid are mixed to form a “noise attenuating material” that “this particular material has unexpectedly provided an excellent medium for isolation and damping of vibrations” (Urella, et al., col. 3 lines 6-8). Urella, et al. achieve a mean performance improvement of 7.7 dB over the range of 31 to 2000 Hz relative to a comparable “Dielectric Gel+Slow Recovery Foam” earcup and seal, and a 10.7 dB performance improvement relative to a “Glycerin+Slow Recovery Foam” earcup seal over the same frequency range (Urella, et al., col. 3, lines 63-68) by including a diluted dilatant material within their soft seals.

Our data indicate that an earcup performs best if it is rigidly suspended. Rigid suspension prevents the earcup from moving in response to acoustic pressure waves by transferring the applied stress from acoustic energy directly to the earcup support, thus preventing earcup movement. Our data thus leads us to a conclusion different from that reported by Urella, et al., namely that it is not an increase in damping that was brought about by their inclusion of dilatant compound, but an increase in support stiffness. If this interpretation is correct, then diluting the dilatant material with silicone oil is an approach that is contraindicated. If the inclusion of dilatant material enhances the stiffness of the soft seal rather than the damping characteristic of the soft seal, then any measure that impedes the ability of the dilatant material to enhance the stiffness of the seal will clearly detract from its potential acoustic performance. Diluting the dilatant material with oil impedes its ability to stiffen. The use of additional slow-recovery foam or dielectric silicone gel between the earcup structure and the user's head (as taught by Urella, et al.) further prevents any stiffening of the dilatant material from effectively transferring acoustic stresses. The foam or gel is an effective decoupling system in what could otherwise be a stiff support.

We propose that to realize maximal acoustic attenuation a dilatant material within an earcup soft seal must be mechanically coupled as stiffly as possible to both the user's head and the earcup shell it supports. There can be no structures such as foam, gels, or liquids that have the effect of structurally decoupling the earcup from the user's head. Our approach has therefore been to develop an earcup soft seal that is filled with material that exhibits the highest possible dilatancy and stiffness, and that is well coupled mechanically between the earcup shell and the user.

A material that exhibits the highest possible dilatancy may be further stiffened by embedding mechanical structures such as a flexible support lattice or hollow microspheres within it. Dow Corning®3179 Dilatant Compound is stiff enough to bounce when dropped, yet flows readily when given enough time. An earcup fitted with a soft seal made from an elastomeric envelope containing nothing but Dow Corning®3179 Dilatant Compound is slightly uncomfortable when first placed on the user's head, but flows to conform exactly to his or her head contours within a minute or so. After the earcup soft seal has conformed to the user's head it is quite comfortable. Mechanical measures such as embedding a structural lattice or microspheres within dilatant material will stiffen the material and increase the time it requires to conform to a user's head, but an enormous increase in acoustic performance is realized as a direct consequence of this increased conformation time.

All of the data presented here were collected using an experimental earcup designed for use by the U.S. military underneath a protective helmet. Accordingly, the internal volume of this experimental earcup is less than half that of a conventional hearing-protection earcup, which reduces its performance relative to a conventionally-sized earcup by roughly 7 dB. Even so, absolute performance levels better than −40 dB from 10 to 2000 Hz have been demonstrated with our new earcup and soft seal.

### BRIEF SUMMARY OF THE INVENTION

Accordingly, an object of the instant invention is to provide an improved noise-protection circumaural earcup soft seal.

Another object of the instant invention is to provide an improved noise-protection circumaural earcup soft seal that substantially holds the earcup it is used with rigidly in space in response to acoustic energy.

Another object of the instant invention is to provide an improved noise-protection circumaural earcup soft seal that is light in weight.

Another object of the instant invention is to provide an improved noise-protection circumaural earcup soft seal that conforms well to the contour of a user's head.

Another object of the instant invention is to provide an improved noise-protection circumaural earcup soft seal that exhibits superior attenuation performance when used with a suitable earcup.

A further object of the instant invention is to provide an improved noise-protection circumaural earcup soft seal that is easily manufactured.

These and additional objects of the instant invention are accomplished with an earcup soft seal that is substantially comprised of dilatant material or with dilatant material substantially filled with hollow microspheres or flexible structural lattices, enclosed in a ring of thin elastomeric material. A material is dilatant if its rate of strain increase decreases with increased shear. Thick mixtures of corn-starch and water are dilatant, for example, as is “quicksand.” Dow Corning® 3179 Dilatant Compound (commonly sold under the trade name “Silly Putty®”) is the dilatant material utilized for the preferred embodiments of the instant invention. The rate of shear imposed upon an earcup soft seal by impinging acoustic energy is rapid relative to the shear rate encountered when forming the seal to the contour of the user's head. The strain that results from this increased shear rate is, therefore, reduced proportionately and the earcup is held substantially rigid-in-space under the influence of rapid, acoustic-induced stresses. Hollow microspheres enhance dilatant stiffness by providing a large rigid surface area within the dilatant material against which the material must flow when the soft seal is deformed, and also serve to lighten the material. Flexible structural lattices serve a similar purpose as the hollow microspheres of the instant invention and may be comprised of coarse open-celled foams or loose bundles of fibers and the like. As with the use of hollow microspheres, the purpose of a flexible structural lattice is to provide surfaces that the dilatant material must flow against as it is deformed, thus increasing the stiffness of the material as a whole.

### BRIEF DESCRIPTION OF THE DRAWINGS

In the following Description of the Preferred Embodiments and the accompanying drawings, like numerals in different figures represent the same structures or elements. The representation in each of the figures is diagrammatic and no attempt is made to indicate actual scales or precise ratios. Proportional relationships are shown as approximations.

FIG. 1 shows an earcup and soft seal of the instant invention.

FIG. 2 shows a cross-sectional view of the earcup soft seal shown in FIG. 1 and an area containing dilatant material.

FIG. 3 shows a cross-sectional view of the earcup soft seal shown in FIG. 1 and an area containing dilatant material with a plurality of embedded microspheres.

FIG. 4 shows a cross-sectional view of the earcup soft seal shown in FIG. 1 and an area containing dilatant material with an embedded flexible structural lattice.

FIG. 5 shows a graph with attenuation data for an exemplary earcup with slow-recovery foam soft seal, with dilatant soft seal, with dilatant plus microspheres soft seal, with dilatant plus flexible structural lattice soft seal, and with no seal.

### DETAILED DESCRIPTION

The parts indicated on the drawings by numerals are identified below to aid in the reader's understanding of the present invention.

10. Earcup

11. Soft seal

12. Soft seal envelope

13. Adhesive surface

14. Dilatant material

15. Microspheres

16. Flexible structural lattice

17. Attenuation data for slow-recovery foam soft seal

18. Attenuation data for dilatant soft seal

19. Attenuation data for dilatant plus microspheres soft seal

20. Attenuation data for dilatant plus structural lattice

21. Attenuation data for no soft seal.

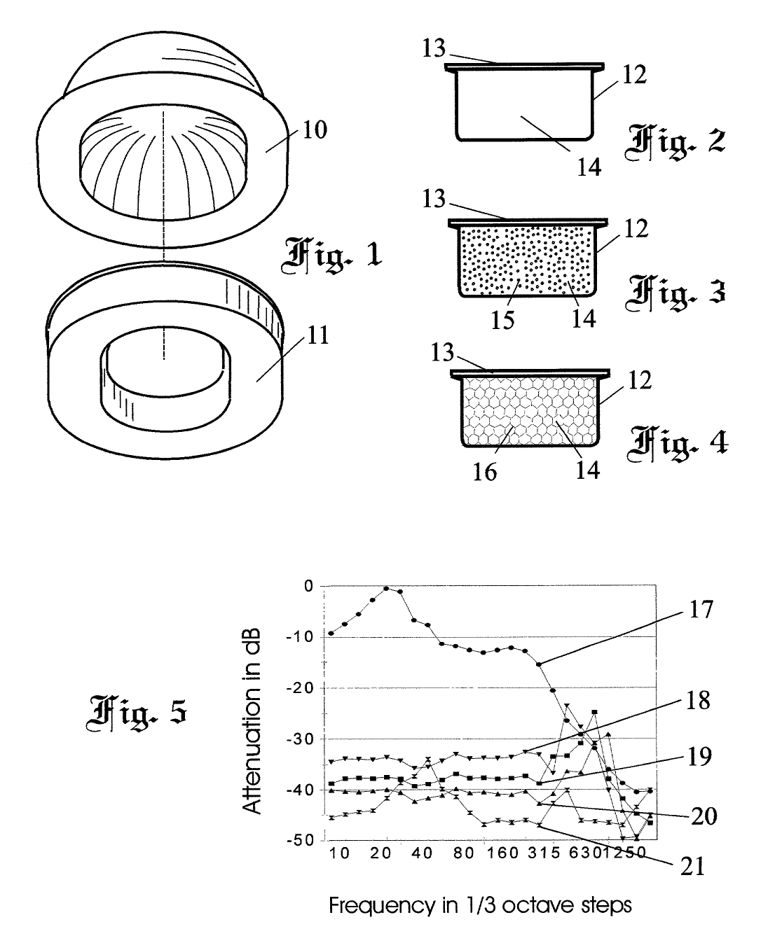

FIG. 1 shows an earcup, 10, and soft seal, 11, of the instant invention.

FIG. 2 shows a cross-sectional view of the earcup soft seal shown in FIG. 1 with envelope, 12, with adhesive surface, 13, and an area containing dilatant material, 14. The envelope of the soft-seal of the instant invention can be made from any suitable elastomeric material, for example from vinyl or urethane thermoplastic elastomer. The dilatant material, 14, completely fills the envelope of the soft seal.

FIG. 3 shows a cross-sectional view of the earcup soft seal shown in FIG. 1 with envelope, 12, with adhesive surface, 13, and an area containing dilatant material, 14, with a plurality of embedded microspheres, 15. The preferred dilatant material of the instant invention, Dow Corning® 3179 Dilatant Compound, has a density of 1.14. This is lighter than the often used glycerin, with a density of 1.27, but is still heavy. The addition of rigid hollow microspheres made, for example, from either glass or ceramic, serves to lighten the dilatant material while retaining and enhancing its dilatancy.

FIG. 4 shows a cross-sectional view of the earcup soft seal shown in FIG. 1 with envelope, 12, with adhesive surface, 13, and an area containing dilatant material, 14, with embedded flexible structural lattice, 16. The flexible structural lattice of FIG. 4 can be made from coarse open-celled foam or a mass of interspersed fibers or the like, and serves the dual purpose of providing structural support to the soft seal and of providing a plurality of surfaces against which the dilatant material must flow if the soft seal is deformed. Drag as the dilatant material flows through the structural lattice adds beneficial stiffness to the soft seal of the instant invention, and the additional stiffness provided by the flexible structural lattice as it stiffens in response to high shear rates aids in holding the earcup it supports rigidly in space.

FIG. 5 shows a graph with attenuation data for an exemplary earcup with slow-recovery foam soft seal, 17, with dilatant soft seal, 18, with dilatant and ceramic microsphere soft seal, 19, with dilatant and structural lattice soft seal, 20, and with no soft seal, 21. Testing was done on a flat-plate coupler with 2 cc aperture using pink noise at roughly 138 dB SPL. The flat-plate coupler is constructed of solid stainless steel, suspended with a spring and damper assembly, and masses slightly more than 27 kilograms. Test results are the average of eight Fourier analyzed samples, averaged bin-wise, and subtracted bin-wise from a reference set of eight samples obtained with no test object present. The earcup used to collect the data for all five cases is an experimental low-volume military type designed for use within a safety helmet. All pink noise generation, data collection and analysis was conducted under computer control.

The peaks shown in the data of FIG. 5 are from resonate conditions in the test setups. The mean attenuation from 10 to 2000 Hz for an earcup with a slow-recovery foam soft seal, shown in attenuation data line 17, is −17.0 dB. The mean attenuation from 10 to 2000 Hz for an earcup with a dilatant soft seal, shown in attenuation data line 18, is −35.3 dB. The soft seal material used for the data of data line 18 was undiluted Dow Corning® 3179 Dilatant Compound. The mean attenuation from 10 to 2000 Hz for an earcup with dilatant and embedded microsphere soft seal, shown in attenuation data line 19, is −37.6 dB. The soft seal material used for the data of data line 19 was 94%, by weight, undiluted Dow Corning® 3179 Dilatant Compound with 6% embedded PQ Corporation Extendospheres® XOL-200 hollow ceramic microspheres. The mean attenuation from 10 to 2000 Hz for an earcup with dilatant soft seal further stiffened with a flexible structural lattice, shown in attenuation data line 20, is −40.2 dB. The soft seal material used for the data of data line 20 was undiluted Dow Corning® 3179 Dilatant Compound with an embedded flexible structural lattice made from a 3M® Heavy Duty Stripping Pad (10112NA). The mean attenuation from 10 to 2000 Hz for an earcup with no soft seal, shown in attenuation data line 21, is −43.4 dB.

The dilatant soft seal performed 18.8 dB better than the slow-recovery foam soft seal, the dilatant plus embedded microsphere soft seal performed 20.6 dB better than the slow-recovery foam soft seal, and the dilatant plus flexible structural lattice soft seal performed 23.2 dB better than the slow-recovery foam soft seal. The dilatant earcup and soft seal was within 8.1 dB of performing as well as an earcup firmly fixed and sealed against a flat-plate coupler with no soft seal whatsoever, the dilatant plus embedded microsphere soft seal and earcup was within 5.8 dB of performing as well as an earcup firmly fixed and sealed against a flat-plate coupler, and the dilatant plus flexible structural lattice soft seal and earcup was within 3.2 dB of performing as well as an earcup firmly fixed and sealed against a flat-plate coupler.

Many modifications and variations of the present invention are possible in light of the above teachings. For example, the shape of the envelope used for the soft seal of the instant invention may be modified to include a plurality of concentric rings or the like. Or, internal structures such as pockets may be included within the earcup soft seal of the instant invention to enhance its stiffness. The earcup soft seal of the instant invention could also be attached to an earcup using an elastic lip or other similar mechanism rather than with adhesive as in the preferred embodiment. It is therefore to be understood that, within the scope of the appended claims, the instant invention may be practiced otherwise than as specifically described.

We claim:

1. A soft seal for use with a circumaural noise-protection earcup or other like headgear incorporating ear protectors designed to reduce noise levels comprised of:
at least one ring of dilatant material, said dilatant material containing no components that substantially reduce the dilatancy of said dilatant material, and an elastomeric envelope enclosing said dilatant material.

2. The soft seal of claim 1 where said elastomeric envelope is comprised of a thin polyurethane film.

3. The soft seal of claim 1 where said elastomeric envelope has an adhesive surface for attachment to a circumaural noise-protection earcup or other like headgear incorporating ear protectors designed to reduce noise levels.

4. A soft seal for use with a circumaural noise-protection earcup or other like headgear incorporating ear protectors designed to reduce noise levels comprised of:
at least one ring of dilatant material, said dilatant material containing no components that substantially reduce the dilatancy of said dilatant material, and a plurality of hollow microspheres embedded within said dilatant material, and an elastomeric envelope enclosing said dilatant material and said plurality of embedded hollow microspheres.

5. The soft seal of claim 4 where said elastomeric envelope is comprised of a thin polyurethane film.

6. The soft seal of claim 4 where said elastomeric envelope has an adhesive surface for attachment to a circumaural noise-protection earcup or other like headgear incorporating ear protectors designed to reduce noise levels.

7. The soft seal of claim 4 where said embedded hollow microspheres are ceramic.

8. The soft seal of claim 4 where said embedded hollow microspheres are glass.

9. A soft seal for use with a circumaural noise-protection earcup or other like headgear incorporating ear protectors designed to reduce noise levels comprised of:
at least one ring of dilatant material, said dilatant material containing no components that substantially reduce the dilatancy of said dilatant material, and a flexible structural lattice embedded within said dilatant material, and an elastomeric envelope enclosing said dilatant material and said embedded flexible structural lattice.

10. The soft seal of claim 9 where said elastomeric envelope is comprised of a thin polyurethane film.

11. The soft seal of claim 9 where said elastomeric envelope has an adhesive surface for attachment to a circumaural noise-protection earcup or other like headgear incorporating ear protectors designed to reduce noise levels.
